(19) United States
(12) Patent Application Publication
(10) Pub. No.: US 2002/0191265 A1
(43) Pub. Date: Dec. 19, 2002

(54) Multi-stage polarization transformer

(76) Inventors: Michael LaGasse, Lexington, MA (US); Morris P. Kesler, Bedford, MA (US); David M. Weitz, Cambridge, MA (US); Mikhail Fridberg, Framingham, MA (US); Hemonth G. Rao, Burlington, MA (US); Jeffrey A. Shultz, West Townsend, MA (US); Kevin Weldon, Townsend, MA (US)

Correspondence Address: RAUSCHENBACH PATENT LAW GROUP, POST OFFICE BOX 387, BEDFORD, MA, 01730, US

(21) Appl. No.: 09/881,508

(22) Filed: Jun. 14, 2001

(51) Int. Cl. G02F 1/03

(52) U.S. Cl. 359/246

(57) ABSTRACT

A multi-stage polarization transformer is described that includes a first polarization transformer stage that receives an optical signal at an input and that generates a first transformed optical signal at an output. The first transformed optical signal has a polarization state within a first predetermined range. A second polarization transformer stage receives the first transformed optical signal at an input and generates a second transformed optical signal at an output. The second transformed optical signal has a polarization state within a second predetermined range. The second predetermined range is less than the first predetermined range.

### FIELD OF THE INVENTION

The present invention relates to controlling the polarization state of an optical signal. In particular, the present invention relates to methods and apparatus for controlling the state of polarization of an optical signal propagating in an optical communication system.

### BACKGROUND OF THE INVENTION

Optical polarization transformers are used to control the state of polarization (SOP) of an optical signal. Polarization transformers may be used in future optical communication systems for several applications. For example, polarization transformers are used for polarization mode dispersion (PMD) compensation. Polarization transformers are also used in fast electrooptic switch arrays. Coherent optical communication systems use polarization transformers to match the time varying SOP of an optical signal received from an optical fiber transmission link to the SOP of a local oscillator signal. In addition, polarization transformers are used to align the polarization state of an optical signal to an axis of a polarization sensitive device, such as a modulator.

Many of these applications require automatic polarization transformers that continuously match the SOP of an optical signal to a desired SOP irrespective of variations of the SOP of the optical signal. Continuous matching is often required in order to avoid unacceptable loss of data. However, known polarization transformers are not always able to continuously match the SOP of an optical signal that exhibits large and/or rapid polarization fluctuations.

### SUMMARY OF THE INVENTION

The multi-stage polarization transformer of the present invention can provide automatic control of the SOP of an optical signal propagating in an optical communication system that exhibits large and/or rapid polarization fluctuations. The multi-stage polarization transformer has numerous advantages over known controllers. One advantage is that the multi-stage polarization transformer has a relatively fast response time. Another advantage is that the multi-stage polarization transformer can transform the SOP of an input optical signal to a linear and orthogonal SOP. Also, the multi-stage polarization transformer has unlimited transformation ranges and reset-free operation. In addition, the multi-stage polarization transformer of the present invention uses a relatively simple control algorithm to achieve these results.

One application for the multi-stage polarization transformer of the present invention is polarization control in a polarization multiplexed optical communication system. In this application, the polarization transformer is used to transform a continuously fluctuating SOP of an optical signal received from a standard optical fiber into a stable state of polarization (SOP) having a predetermined polarization.

Accordingly, the present invention features a multi-stage polarization transformer that includes a first polarization transformer stage that receives an optical signal at an input and that generates a first transformed optical signal at an output. The optical signal may be a time multiplexed optical signal. The optical signal may also be a polarization multiplexed signal. The first transformed optical signal has a polarization state within a first predetermined range.

A second polarization transformer stage receives the first transformed optical signal at an input and generates a second transformed optical signal at an output. The second transformed optical signal has a polarization state within a second predetermined range. The second predetermined range is less than the first predetermined range. The first predetermined range is typically selected to have a polarization coordinate space that can be rapidly transformed by the second polarization transformer into the second predetermined range without requiring a reset that may cause loss of data while the reset is being preformed. In one embodiment, the second predetermined range at least partially overlaps with the first predetermined range. In other embodiments, the second predetermined range does not substantially overlap with the first predetermined range.

In one embodiment, at least one of the first and the second polarization transformers is a variable retardation, fixed-axis polarization transformer. In another embodiment, at least one of the first and the second polarization transformers is a fixed retardation, endlessly rotatable optical retardation plate. The first and the second polarization transformers may be any type of polarization transformer. For example, the first and the second polarization transformers may be an electro-ceramic polarization transformer, a magneto-optic polarization transformer, an electro-optic polarization transformer, or a material deformation induced polarization transformer, such as a fiber squeezer polarization transformer.

In one embodiment, the multi-stage polarization transformer includes a feedback control apparatus that is used to control the polarization state of the first and the second transformed optical signal. A polarization selective element is optically coupled to the output of the second polarization transformer. The polarization selected element passes an optical signal having a predetermined polarization state. An optical detector is optically coupled to a portion of the output of the polarization selective element. The optical detector generates an electrical signal that is related to the amplitude of the optical signal having the predetermined polarization state.

A control circuit receives the electrical signal generated by the optical detector at an electrical input. An electrical output of the control circuit is electrically coupled to a control input of at least one of the first and the second polarization transformers. The control circuit generates a control signal at the electrical output that controls the polarization state of the first and the second transformed optical signal.

Electrical dithering may be used to generate an error signal on the multi-stage polarization transformer. A dither signal generator is used to produce a dither signal for modulating the polarization state of the transformed optical signals. A synchronous demodulator may process the dither signal and generate an error signal. In one embodiment, a dither signal generator is electrically connected to an electrical input of the first polarization transformer. The dither signal generator modulates the polarization state of the first and second transformed optical signal. The modulated signal is detected and the amplitude of the detected signal is fed back to the polarization transformer.

In another embodiment, a dither signal generator is electrically connected to the second polarization transformer and the dither signal generator modulates the polarization state of the second transformed optical signal. In yet another embodiment, the dither signal generator is electrically connected to the first and the second polarization transformer and the dither signal generator modulates the polarization state of the first and second transformed optical signal.

A polarization selective element is optically coupled to the output of the second polarization transformer. The polarization selective element passes an optical signal having a predetermined polarization state. An optical detector is optically coupled to an output of the polarization selective element. The optical detector generates an electrical signal having an amplitude that is related to an amplitude of the optical signal having the predetermined polarization state.

A narrow band electrical filter passes a filtered electrical signal that has a frequency that is related to the frequency of the dither signal. A control circuit receives the filtered electrical signal at an input and generates a control signal at an electrical output. The output is electrically coupled to a control input of at least one of the first and the second polarization transformers. The control signal controls the polarization state of at least one of the first and the second transformed optical signal.

The present invention also features a method of transforming a polarization state of an input optical signal to a predetermined polarization state. The input optical signal may have an arbitrary polarization state. The method includes transforming a polarization state of an input optical signal to a first transformed optical signal having a polarization state within a first predetermined range. In one embodiment, the first transformed optical signal has a polarization state approximately in the center of the first predetermined range.

The first transformed optical signal is then transformed to a second transformed optical signal having a polarization state within a second predetermined range. The second predetermined range is less than the first predetermined range. In one embodiment, the second transformed optical signal has a polarization state approximately in the center of the second predetermined range.

The method may include feedback control. In one embodiment, the polarization state of the first transformed optical signal is changed in response to the polarization state of the second transformed optical signal. The polarization state of the first transformed optical signal may be adjusted to the desired polarization state by dithering the polarization state of the first transformed optical signal with a first frequency.

A portion of the second transformed optical signal having a predetermined state of polarization is detected. The portion of the second transformed optical signal having the predetermined state of polarization is converted into an electrical signal. The dither superimposed onto the electrical signal is detected. The polarization state of the first transformed optical signal is then adjusted in response to the detected dither signal. The polarization state of the first transformed optical signal may be adjusted to align the polarization state of the second transformed optical signal to an axis of a polarization sensitive element.

The present invention also features a multi-stage polarization transformer for transforming the polarization states of an orthogonally polarized polarization multiplexed optical signal. The multi-stage polarization transformer includes a first polarization transformer stage that receives an orthogonally polarized polarization multiplexed optical signal at an input and that has an output that generates a first transformed orthogonally polarized polarization multiplexed optical signal. The first transformed orthogonally polarized polarization multiplexed optical signal has orthogonal polarization states within a first predetermined range.

A second polarization transformer stage receives the first transformed orthogonally polarized polarization multiplexed optical signal at an input and generates a second transformed orthogonally polarized polarization multiplexed optical signal at an output. The second transformed orthogonally polarized polarization multiplexed optical signal has polarization states within a second predetermined range. The second predetermined range is less than the first predetermined range. In one embodiment, the second polarization transformer generates a second transformed orthogonally polarized polarization multiplexed optical signal that has linear and orthogonal polarization states.

The present invention also features a method of transforming polarization states of an orthogonally polarized polarization multiplexed optical signal to an orthogonally polarized polarization multiplexed optical signal having predetermined polarization states. The method includes transforming an input optical signal having an orthogonally polarized polarization multiplexed optical signal to a first transformed orthogonally polarized polarization multiplexed optical signal having polarization states within a first predetermined range.

The polarization states of the first transformed orthogonally polarized polarization multiplexed optical signal are then transformed to a second transformed orthogonally polarized polarization multiplexed optical signal having polarization states within a second predetermined range. The second predetermined range is less than the first predetermined range. In one embodiment, the polarization states of the second transformed orthogonally polarized polarization multiplexed optical signal are substantially linear.

### BRIEF DESCRIPTION OF THE DRAWINGS

This invention is described with particularity in the appended claims. The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 shows a Poincare sphere that graphically represents polarization transformations caused by propagating an optical signal though a two-stage polarization transformer according to the present invention.

FIG. 2 illustrates a schematic diagram of a two-stage electro-optic polarization transformer according to the present invention.

FIG. 3 illustrates a schematic diagram of a two-stage electro-optic polarization transformer for transforming the polarization states of an orthogonally polarized polarization multiplexed optical signal according to the present invention.

FIG. 4 illustrates a flow chart of one embodiment of a method of operating the two-stage electro-optic polarization transformer of the present invention.

FIG. 5 shows a Poincare sphere that graphically represents an example of polarization transformations caused by propagation an optical signal though a two-stage, fixed retardation, variable axis retardation polarization transformer of the present invention.

FIG. 6 shows a Poincare sphere that graphically represents an example of polarization transformations caused by propagation an optical signal though a two-stage, fixed axis, variable retardation polarization transformer of the present invention.

### DETAILED DESCRIPTION

There are several types of known optical polarization transformers. Known polarization transformers include electro-optic, electro-ceramic, magneto-optic, material deformation induced, and liquid crystal type polarization transformers. These polarization transforms include retardation waveplates. The retardation waveplates can be generally characterized as fixed retardation (i.e. fixed thickness) and variable angle, fixed angle and variable retardation (i.e. variable thickness), or a combination of both fixed retardation and variable angle and fixed angle and variable retardation.

Polarization transformers that use retardation waveplates having fixed angle and variable retardation are advantageous because they can transform the polarization of an optical signal to an orthogonal state. Some applications, such as polarization multiplexing, require orthogonal polarization states. However, these polarization transformers cannot track endlessly. A rewind may be necessary when the polarization transformer has reached a limit where normal operation cannot be achieved.

Rewind is defined herein as reconfiguring or rewinding the polarization transformer drivers so that they generate drive voltages that are within the normal operating range of the polarization transformer. Rewinds are undesirable because they reduce the response time of the transformer and can result in an unacceptable loss of data. Polarization transformation schemes that require rewind operation are undesirable in communication systems.

One type of polarization transformer that uses retardation waveplates having fixed angle and variable retardation is an electro-ceramic polarization transformer. An example of an electro-ceramic polarization transformer is a lead-doped lanthanum zirconate titanate (PLZT) polarization transformer. Electro-ceramic polarization transformers are advantageous because they have relatively fast response times. Electro-ceramic polarization transformers also have relatively low insertion loss, low polarization mode dispersion (PMD), and low polarization dependent loss (PDL). In addition, electro-ceramic polarization transformers are relatively compact and inexpensive.

Furthermore, electro-ceramic polarization transformers have well-defined voltage-polarization transfer functions. Consequently, accurate predictions of the output polarization state as a function of input polarization state and applied voltage can be made. In addition, it is relatively easy to characterize operating points that are non-optimized. These features simplify designing electro-ceramic polarization transformers into a system.

However, electro-ceramic polarization transformers also have some disadvantages. One disadvantage of electro-ceramic polarization transformers is that their electro-optic efficiency is a relatively strong function of temperature, which is undesirable for some system applications. Another disadvantage is that electro-ceramic polarization transformers may not provide endless polarization control and, therefore, may require rewinds.

For example, some types of electro-ceramic polarization transformers are designed so that a voltage applied across an electro-ceramic plate changes the equivalent thickness of the plate and thus changes the equivalent order of the waveplate. Therefore, applying a voltage to the plate of these transformers changes the polarization of a signal propagating through the plate in a known way. When these electro-ceramic polarization transformers track polarization changes, higher and higher drive voltages are required. Eventually, the drive voltages reach the maximum operating voltage limit of the device. This limit may be set by the drive circuitry or it may a result of a physical limitation of how much voltage can be applied across the electro-ceramic material before the crystal itself is damaged. Once the operating voltage limit is reached, a reset may need to be performed.

Electro-ceramic polarization transformers may also have a lower drive voltage limit. The lower voltage limit is caused by the periodicity of the waveplate operation. For example, a voltage applied to an electro-ceramic plate may transform the plate from a half-wave plate to a full-wave plate. Increasing the voltage will transform the plate back into a half-wave plate (i.e. (n+1)λ/2) and then into a full wave-plate (i.e. nλ). In operation, there are multiple voltage settings that achieve the same polarization transformations. However, ramping the drive voltage from the limiting value to another known good value may induce polarization changes that are rapidly varying and that may be transformed outside the acceptable polarization ranges referred to above. In this event, a rewind may need to be performed.

Polarization transformers that use retardation waveplates of fixed retardation and variable angle are advantageous because they can achieve rewind free operation and, therefore, do not require a reset. These polarization transformers, however, do not have well-defined transfer function between applied voltage and polarization transformation. Therefore, it is difficult to predict if these transformers are operating in a range where the polarization transformation properties are non-optimized.

Retardation waveplates having fixed retardation and variable angle can be mechanically rotated waveplates in bulk optic or fiber optic form. Mechanically rotated waveplates, however, have inherently slow control speeds (on order of hundreds of milliseconds) and are not suitable for use in high-speed optical communication systems. Retardation waveplates having fixed retardation and variable angle can also be electro-optically induced retardation waveplates in bulk optic or integrated-optic form. Electro-optically induced retardation plates have relatively fast control speed and can be used in high-speed optical communication systems.

One type of known electro-optically induced polarization transformer that can be configured as retardation waveplates having fixed retardation and variable angle is a lithium niobate polarization transformer. Waveguides are formed in a lithium niobate substrate. For example, z-propagating waveguides can be formed in x-cut lithium niobate by titanium diffusion. Electrodes are formed on the top of the substrate to create retardation waveplate stages. The polarization transformers are typically configured to operate as a series of cascaded retardation waveplates. Each of the series of cascaded waveplates is biased to achieve a certain angle and magnitude of the birefringment axes.

Lithium niobate polarization transformers are advantageous because they have relatively fast response times and have relatively low drive voltages. Also, lithium niobate polarization transformers provide endless polarization control and can provide rewind free operation. Lithium niobate polarization transformers, however, can have temperature and aging-induced bias voltage drifts that can effect performance.

In theory, polarization transformers that use endlessly rotatable retardation plates are desirable because they do not require rewind or reset cycles and, therefore can be operated with a relatively simple and fast control algorithm. For example, a single quarter-wave plate followed by another quarter-wave plate or a half-wave plate can, in theory, provide endless, reset-free transformation from any varying general input SOP into an arbitrary fixed output SOP. A combination of a first-quarter wave plate, a half-wave plate, and a second quarter-wave plate in any order can, in theory, provide reset-free transformations from any arbitrary varying input SOP into any arbitrary output SOP.

Automatic polarization transformers for optical communication system must be able to transform the polarization of an optical signal from an arbitrary SOP to a varying predetermined SOP. Automatic polarization transformers for optical communication systems must also be able to track large and rapid fluctuations in polarization.

Tracking polarization is difficult because the control action of polarization transformers is highly nonlinear and polarization control parameters are highly coupled. The control action also depends on the input and output states of polarization. Some known polarization transformers use stepped dither control methods. The stepped dither control method sequentially steps the control voltage and measures the associated error signal. If the measured error signal improves when the plate voltage is stepped, then the plate voltage is adjusted to correspond to the improved error signal.

The stepped dither method works well for many applications, but has some disadvantages. One disadvantage is that the efficiency of the stepped dither method is relatively low. Another disadvantage is that the efficiency of the stepped dither algorithm depends nonlinearly on the input and output states of polarizations. Another disadvantage is that the dither efficiency can depend on the voltage applied to the retardation waveplates. Yet another disadvantage is that the control actions of each of the retardation waveplates are not orthogonal, but rather are non-linear.

The above disadvantages of polarization transformers using the stepped dither method limits the performance and usefulness of the polarization transformer. Polarization transformers using the stepped dither method cannot always track the SOP trajectory of an optical signal and transform the polarization state of the optical signal to a predetermined polarization state. Therefore, the stepped dither method using known polarization transformers may not be suitable for some applications in optical communication systems.

The multi-stage polarization transformer of the present invention overcomes the limitations of known polarization transformers using the stepped dither approach. Multi-stage polarization transformer is defined herein as two or more polarization transformer stages where each stage transforms the SOP of an optical signal to another SOP within a predetermined range. Each of the stages includes at least one polarization transformer, but may include any number of polarization transformers.

For example, a multi-stage polarization transformer according to the present invention uses a first polarization transformer stage that generates a first transformed optical signal having a SOP within a first predetermined range. A second polarization transformer stage receives the first transformed optical signal and generates a second transformed optical signal having a SOP within a second predetermined range. The second predetermined range is less than the first predetermined range. Any type of polarization transformer can be used with the multi-stage polarization transformer of the present invention.

The operation of the polarization transformer of the present invention can be graphically illustrated with Poincare sphere. The Poincare sphere is a graphical tool in real, three-dimensional space that uniquely represents any state of polarization by a point on or within the Poincare sphere. A point on the surface of the Poincare sphere represents completely polarized light. A point within the volume of the Poincare sphere represents partially polarized light, which can be considered a superposition of polarized and unpolarized light.

The distance of the point from the center of the Poincare sphere gives the degree of polarization (DOP) of the signal, which ranges from zero at the origin (for unpolarized light) to unity at the sphere surface (completely polarized light). Points that are close together on the sphere represent polarizations that are similar. The interferometric contrast between two polarizations is related to the distance between the corresponding two points on the sphere. For example, orthogonal polarization states (with zero interferometic contrast) are diametrically opposite one another on the sphere.

Linear states map to the equator and circular states map to the poles of the Poincare sphere. Elliptical states are continuously distributed between the equator and the poles. Right-hand and left-hand elliptical states occupy the northern and southern hemispheres, respectively. A continuous evolution of polarization is represented as a continuous path. A path on the sphere graphically illustrates the polarization history of a signal. Thus, a path on the Poincare sphere represents a polarization transform.

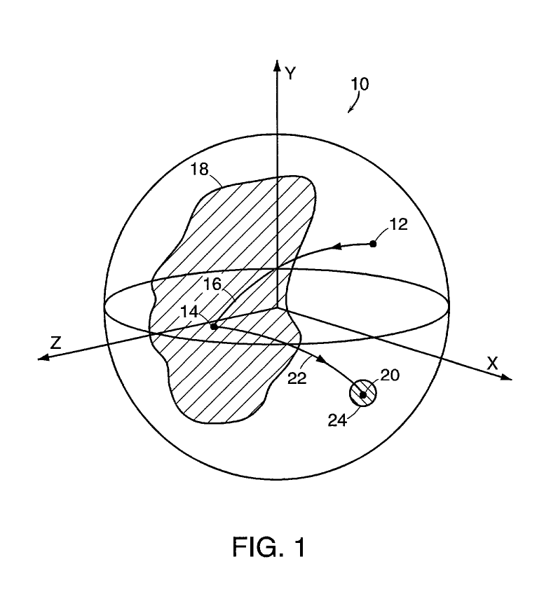

Referring more particularly to the figures, FIG. 1 shows a Poincare sphere 10 that graphically represents polarization transformations caused by propagation an optical signal though a two-stage polarization transformer according to the present invention. An optical signal having an arbitrary SOP, which is represented by a first point 12 on the Poincare sphere 10, enters into the polarization transformer. A first polarization transformer stage performs a first polarization transform and generates a first transformed optical signal having a polarization state that is represented by a second point 14 on the Poincare sphere 10. The first polarization transform is represented as a path 16 on the Poincare sphere 10 from the first point 12 to the second point 14. The second point 14 is within a first predetermined range 18 of polarization states on the Poincare sphere 10.

A second polarization transformer stage receives the first transformed optical signal and performs a second polarization transform and generates a second transformed optical signal having a polarization state that is represented by a third point 20 on the Poincare sphere 10. The second polarization transform is represented as a path 22 on the Poincare sphere 10 from the first point 12 to the second point 14. The third point 20 is within a second predetermined range 24 of polarization states on the Poincare sphere 10.

The second predetermined range 24 of polarization states on the Poincare sphere 10 is less than the first predetermined range 18 of polarization states. In one embodiment, the second predetermined range 24 does not overlap with the first predetermined range, as shown in FIG. 1. In other embodiments, the second predetermined range 24 of polarization states on the Poincare sphere 24 at least partially overlaps with the first predetermined range 18 of polarization states on the Poincare sphere 10 (not shown). The second predetermined range 24 may be completely within the first predetermined range 24.

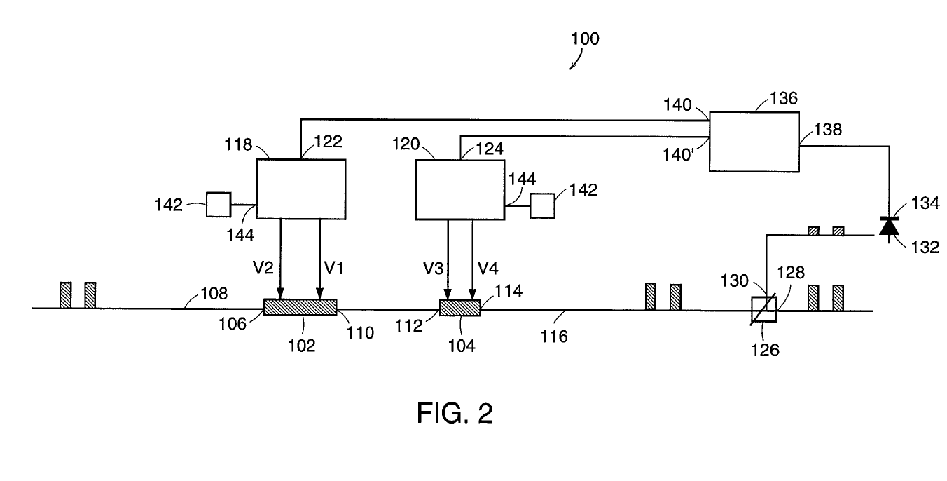

FIG. 2 illustrates a schematic diagram of a two-stage electro-optic polarization transformer 100 according to the present invention. The two-stage polarization transformer 100 includes a first stage polarization transformer 102 that performs a first polarization transform and a second stage polarization transformer 104 that performs a second polarization transform. The first stage polarization transformer 102 has an optical input 106 that receives a single mode optical fiber 108. An output 110 of the first stage polarization transformer 102 is optically coupled to an input 112 of the second stage polarization transformer 104. The output 114 of the second stage 104 is optically coupled to an optical fiber 116. The optical fiber can be a single mode or a polarization maintaining optical fiber.

The first 102 and the second polarization transformer stage 104 can be any type of electrically controllable polarization transformer. In one embodiment, each of the first and the second stage polarization transformers 102, 104 include two electrically controlled retardation waveplates. However, in other embodiments, the first 102 and the second stage polarization transformer 104 can have any number of retardation waveplates. The first 102 and the second stage polarization transformer 104 can be positioned on a single substrate or can be positioned on multiple substrates. In addition, retardation waveplates comprising the first 102 and the second stage polarization transformer 104 can be positioned on a single substrate or can be positioned on multiple substrates.

The two-stage polarization transformer 100 also includes a first 118 and a second driver 120 that generates driving voltages that control the retardation waveplates in the first 102 and the second stage polarization transformer 104, respectively. The first 118 and the second driver 120 includes a first 122 and second control input 124, respectively, that receives a control signal that causes the first 118 and the second driver 120 to change the voltage applied to the retardation waveplates.

A polarization sensitive element 126 is optically coupled to the optical fiber 116 that is optically coupled to the output 114 of the second stage polarization transformer 104. In one embodiment, the polarization sensitive element 126 is a polarization beam splitter. The polarization sensitive element 126 passes an optical signal that has a predetermined polarization state.

The two-stage polarization transformer 100 includes feedback control to adjust the voltages generated by the first 118 and the second driver 120 and, therefore, the polarization transforms performed by the first 102 and the second stage polarization transformers 104, respectively. An optical feedback signal is extracted from the output 114 of the second stage polarization transformer 104.

In one embodiment, the optical feedback signal is an optical signal that is orthogonally polarized relative to the optical signal having the predetermined polarization state. In this embodiment, a polarization beam splitter may be used to pass the optical signal having the predetermined polarization state at a first port 128. An optical signal having a polarization that is orthogonally polarized relative to the predetermined polarization is passed at the second port 130. An optical detector 132 is optically coupled to the second port 130 of the polarization beam splitter 126. The optical detector 132 generates an electrical feedback signal at an output 134. The amplitude of the electrical feedback signal is related to the amplitude of the orthogonally polarized optical signal.

In another embodiment, the optical feedback signal is a portion of the optical signal passed by the polarization sensitive element 126. In this embodiment, an optical coupler (not shown) is used to couple a portion of the optical signal passed by the polarization sensitive element 126.

A feedback control circuit 136 has an electrical input 138 that is electrically coupled to the output 134 of the optical detector 132. The feedback control circuit 136 receives the electrical control signal and generates electrical control signals at outputs 140, 140′. The outputs 140, 140′ of the feedback control circuit 136 are electrically coupled to the control inputs 122, 124 of the drivers 118, 120, respectively. The electrical control signals generated by the feedback control circuit 136 causes the first 118 and the second driver 120 to generate new driving voltages that change the polarization transform performed by the first 102 and the second stage polarization transformer 104.

There are many other embodiments for the feedback control of the two-stage polarization transformer 100 of the present invention. For example, separate control circuits (not shown) can be used to generate the control signals for the first 118 and the second driver 120. Also, in one embodiment, the control circuit 136 provides a control signal to only one of the first 118 and the second driver 120. In addition, in one embodiment, the control circuit 136 receives the drive voltage produced by at least one of the first 118 and the second driver 120 and generates a control signal in response to the drive voltage.

In one embodiment, the two-stage polarization transformer of the present invention uses dithering to identify the polarization states. A dither generator 142 is electrically coupled to an input 144 of at least one of the first 118 and the second driver 120. The dither generators 142 generate a dither signal at a first dither frequency that dithers the polarization of the transformed optical signals. The optical detector detects a dithered optical signal and converts it to a dithered electrical signal. The control circuit 136 processes the detected signal and generates an error signal. The control circuit 136 may include a narrowband filter that passes the dithered electrical signal and rejects substantially all other frequencies. In one embodiment, the control circuit 136 processes the detected signal with a synchronous demodulator. The synchronous demodulator locks onto the first dither frequency and generates an error signal.

In operation, the first stage polarization transformer 102 receives an input optical signal having an arbitrary SOP. The bias voltage generated by the first driver 118 causes the retardation waveplates in the first stage polarization transformer 102 to transform the polarization of the input optical to a first transformed optical signal having a SOP that is within a first predetermined range 18 (FIG. 1). In one embodiment, a dither signal generated by the dither signal generator is superimposed on the bias voltage and dithers the SOP of the first transformed optical signal.

The second stage polarization transformer 104 receives the first transformed optical signal. The bias voltage generated by the second driver 120 causes the retardation waveplates in the second stage 104 to transform the polarization of the first transformed optical signal to a second transformed optical signal having a SOP that is within a second predetermined range 24 (FIG. 1). The second predetermined range is less than the first predetermined range as shown in FIG. 1.

The polarization sensitive element 126 passes a portion of the second transformed optical signal having a predetermined polarization at the first port 128. In one embodiment, the polarization sensitive element 126 is a polarization beam splitter that passes an optical signal at the second port 130 that is orthogonally polarized relative to the optical signal having the predetermined polarization.

The detector 132 detects the portion of the second transformed optical signal and generates an electrical signal that is related to the orthogonally polarized optical signal. The control circuit 136 receives the detected signal and processes the detected signal to generate an error signal at the outputs 140, 140′. The outputs 140, 140′ are coupled to the control input 122, 124 of the first 118 and the second driver 120, respectively. The error signal causes at least one of the first 118 and the second driver 120 to change the drive voltage applied to retardation waveplates in at least one of the first 102 and the second stage 104.

In one embodiment, the control circuit uses synchronous demodulation to generate the error signal. Numerous types of dither control algorithms can be used to determine the bias voltage applied to the retardation waveplates. The first 118 and the second driver 120 bias the retardation waveplates to minimize or to maximize the electrical signal generated passed by the narrowband filter 146. The synchronous demodulator locks onto the dither frequency and generates an error signal.

One advantage of the multi-stage polarization transformer of the present invention is that a polarization transformer can be constructed so that each of the multi-stage polarization transformers operates in a range that works efficiently and that does not require a rewind.

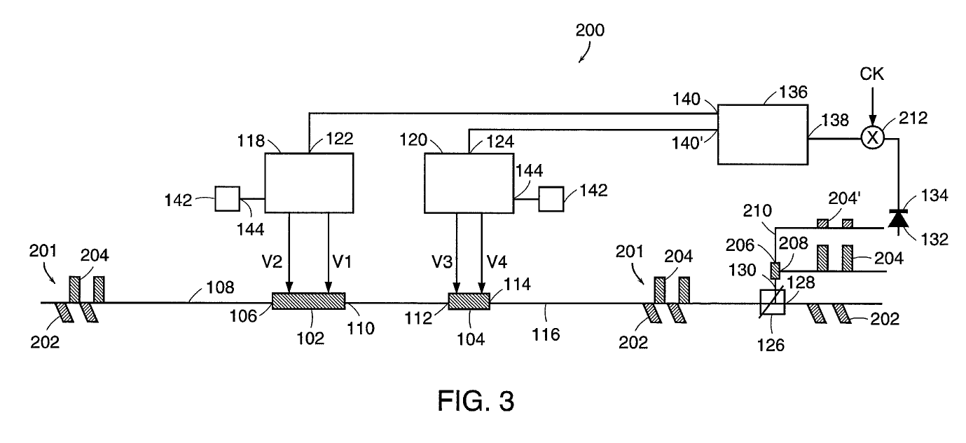

FIG. 3 illustrates a schematic diagram of a two-stage electro-optic polarization transformer 200 for transforming the polarization states of an orthogonally polarized polarization multiplexed optical signal 201 according to the present invention. The two-stage electro-optic polarization transformer 200 is similar to the polarization transformer of FIG. 2, but is designed to transformer the polarization states of an orthogonally polarized polarization multiplexed optical signal 201 comprising a first 202 and a second component 204.

The polarization sensitive element 126 that is optically coupled to the output 114 of the second stage polarization transformer 104 passes the first component 202 of the polarization multiplexed optical signal 201 at the first port 128. The polarization sensitive element 126 also passes the second component 204 of the polarization multiplexed optical signal 201 at the second port 130.

The two-stage polarization transformer 200 includes a coupler 206 that couples a portion 204′ of the second component 204 for detection. The detector 132 detects the coupled portion 204′ of the second component 204 of the polarization multiplexed optical signal 201. The optical detector 132 generates an electrical feedback signal at an output 134. The amplitude of the electrical feedback signal is related to the amplitude of the coupled portion 204′ of the second component 204 of the polarization multiplexed optical signal 201.

In one embodiment, the first 202 and the second components 204 of the polarization multiplexed optical signal 201 are identified with different dither frequencies. That is, the first component 202 is dithered at a first frequency and the second component 204 of the polarization multiplexed optical signal 201 is dithered at a second frequency. A mixer 212 may be used to mix a clock signal with the electrical feedback signal generated by the optical detector 132. The mixer 212 generates a signal that has a frequency that identifies the component of the polarization multiplexed optical signal 201.

The mixer 212 is electrically connected to the input 138 of the feedback control circuit 136. The feedback control circuit 136 receives the signal generated by the mixer 212 and generates electrical control signals at outputs 140, 140′ in response to the received signal. The outputs 140, 140′ of the feedback control circuit 136 are electrically coupled to the control inputs 122, 124 of the drivers 118, 120, respectively. The electrical control signals generated by the feedback control circuit 136 causes the first 118 and the second driver 120 to generate new driving voltages that change the polarization transform performed by the first 102 and the second stage polarization transformer 104.

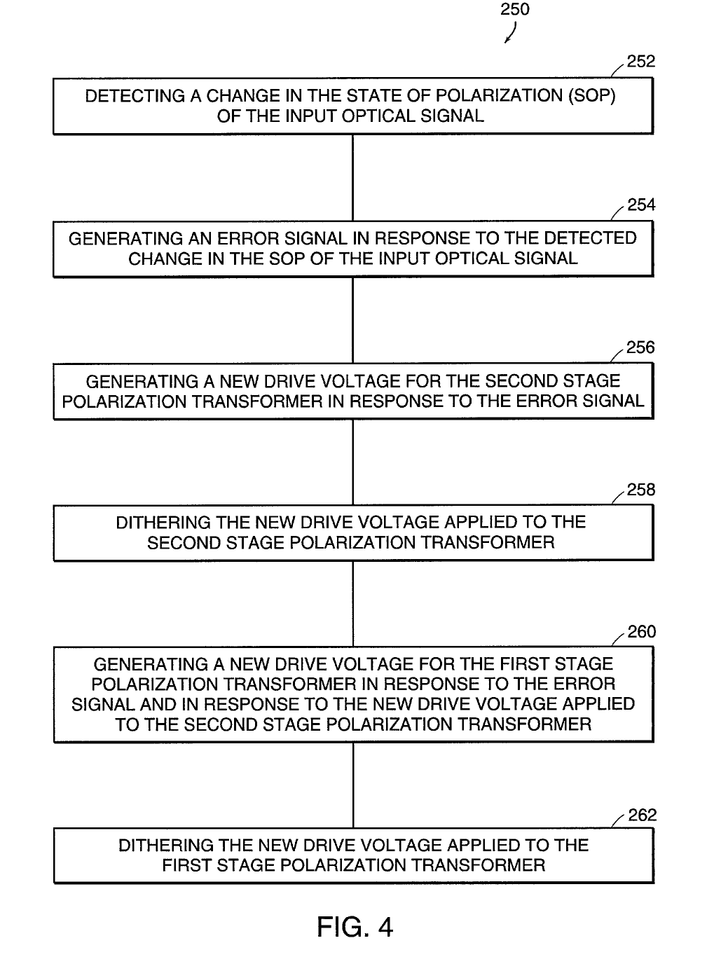

FIG. 4 illustrates a flow chart 250 of one embodiment of a method of operating the two-stage electro-optic polarization transformer of the present invention. The method includes the step 252 of detecting a change in the SOP of the input optical signal. The optical detector 132 generates an electrical feedback signal at an output 134 that indicates a change in the SOP of the input optical signal.

The method also includes the step 254 of generating an error signal in response to the detected change in the SOP of the input optical signal. The feedback control circuit 136 receives the signal generated by the detector 132 or the mixer 212 and generates an error signal. In one embodiment, the feedback control circuit 136 generates the error signal by using synchronous demodulation. In another embodiment, the feedback control circuit 136 generates the error signal by using a stepped dither method.

The method also includes the step 256 of generating a new drive voltage for the second stage polarization transformer 104 in response to the error signal. The feedback control circuit 136 instructs the second driver 120 to generate the new drive voltage. The method also includes the step 258 of dithering the new drive voltage applied to the second stage polarization transformer 104. In one embodiment, the feedback control circuit 136 generates the error signal by processing the detected dither signal.

The method also includes the step 260 of generating a new drive voltage for the second stage polarization transformer 102 in response to the error signal and in response to the new drive voltage applied to the second stage polarization transformer 104. The feedback control circuit 136 instructs the first driver 118 to generate the new drive voltage for the first stage polarization transformer 102. The method may include the step 258 of dithering the new drive voltage applied to the first stage polarization transformer 102. In one embodiment, the feedback control circuit 136 generates the error signal by processing the detected dither signal.

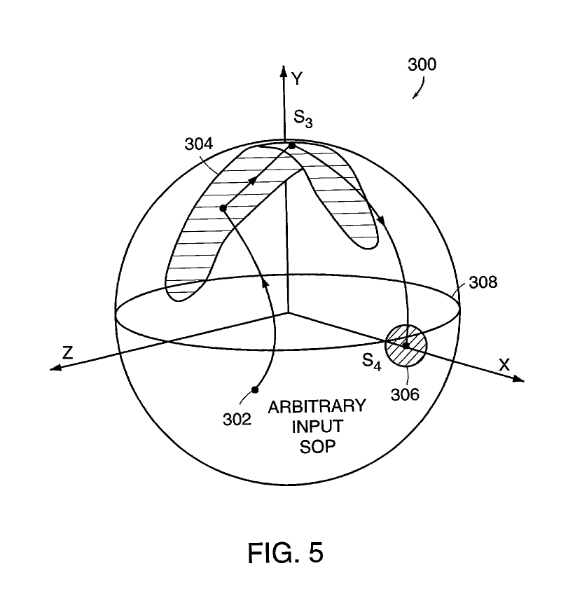

FIG. 5 shows a Poincare sphere 300 that graphically represents an example of polarization transformations caused by propagation an optical signal though a two-stage, fixed retardation, variable axis retardation polarization transformer of the present invention. An input optical signal having an arbitrary SOP is received by the first stage at a first point 302. The first stage transforms the arbitrary SOP of the input optical signal to a first transformed optical signal having a SOP in a saddle-shaped region 304 of the Poincare sphere 300. The second stage transforms the SOP of the first transformed optical signal from the saddle-shaped region 304 to a second region 306 of the Poincare sphere 300 near the equator 308.

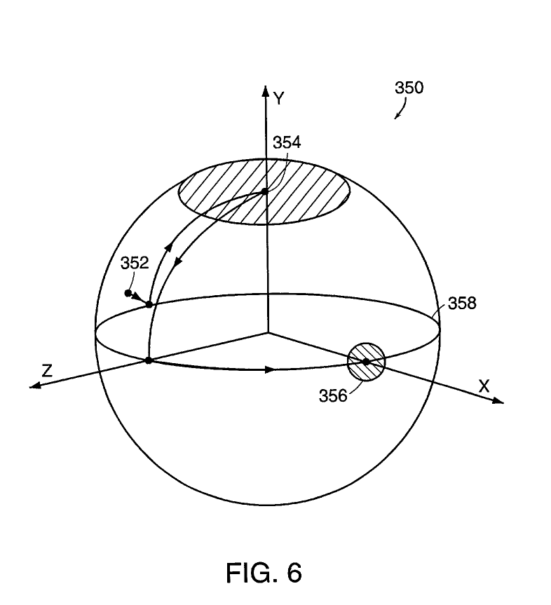

FIG. 6 shows a Poincare sphere 350 that graphically represents an example of polarization transformations caused by propagation an optical signal though a two-stage, fixed axis, variable retardation polarization transformer of the present invention. An input optical signal having an arbitrary SOP is received by the first stage at a first point 352. The first stage transforms the arbitrary SOP of the input optical signal to a first transformed optical signal having a SOP near the pole 354 of the Poincare sphere 350. The second stage transforms the SOP of the first transformed optical signal from the pole 354 to a second region 356 of the Poincare sphere 350 near the equator 358.

### Equivalents

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A multi-stage polarization transformer comprising:
a. a first polarization transformer stage having an input that receives an optical signal and having an output that generates a first transformed optical signal, the first transformed optical signal having a polarization state within a first predetermined range; and
b. a second polarization transformer stage having an input that receives the first transformed optical signal and an output that generates a second transformed optical signal, the second transformed optical signal having a polarization state within a second predetermined range, wherein the second predetermined range is less than the first predetermined range.

2. The multi-stage polarization transformer of claim 1 wherein the optical signal comprises a time multiplexed optical signal.

3. The multi-stage polarization transformer of claim 1 wherein the first predetermined range has a polarization coordinate space that can be transformed by the second polarization transformer into the second predetermined range.

4. The multi-stage polarization transformer of claim 1 wherein the second predetermined range at least partially overlaps with the first predetermined range.

5. The multi-stage polarization transformer of claim 1 wherein the second predetermined range does not substantially overlap with the first predetermined range.

6. The multi-stage polarization transformer of claim 1 wherein at least one of the first and the second polarization transformers comprises a variable retardation, fixed-axis polarization transformer.

7. The multi-stage polarization transformer of claim 1 wherein at least one of the first and the second polarization transformers comprises fixed thickness, endlessly rotatable optical retardation plates.

8. The multi-stage polarization transformer of claim 1 wherein at least one of the first and the second polarization transformers comprise an electro-ceramic polarization transformer.

9. The multi-stage polarization transformer of claim 1 wherein at least one of the first and the second polarization transformer comprise a magneto-optic polarization transformer.

10. The multi-stage polarization transformer of claim 1 wherein at least one of the first and the second polarization transformer comprise an electro-optic polarization transformer.

11. The multi-stage polarization transformer of claim 1 wherein at least one of the first and the second polarization transformer comprise a material deformation induced polarization transformer.

12. The multi-stage polarization transformer of claim 1 further comprising:
a. a polarization selective element that is optically coupled to the output of the second polarization transformer, the polarization selected element passing an optical signal having a predetermined polarization state;
b. an optical detector that is optically coupled to a portion of the output of the polarization selective element, the optical detector generating an electrical signal that is that is related to an amplitude of the optical signal having the predetermined polarization state; and
c. a control circuit having an electrical input that receives the electrical signal generated by the optical detector and an electrical output that is electrically coupled to a control input of at least one of the first and the second polarization transformers, the control circuit generating a control signal at the electrical output that controls the polarization state of at least one of the first and the second transformed optical signal.

13. The multi-stage polarization transformer of claim 1 further comprising:
a. a dither signal generator that is electrically connected to an electrical input of the first polarization transformer, the dither signal generator modulating the polarization state of the first and the second transformed optical signal;
b. a polarization selective element that is optically coupled to the output of the second polarization transformer, the polarization selected element passing an optical signal having a predetermined polarization state;
c. an optical detector that is optically coupled to an output of the polarization selective element, the optical detector generating an electrical signal having an amplitude that is related to an amplitude of the optical signal having the predetermined polarization state;
d. a narrow band electrical filter that passes a filtered electrical signal that is related to a frequency of the dither signal; and
e. a control circuit having an electrical input that receives the filtered electrical signal and an electrical output that is electrically coupled to a control input of at least one of the first and the second polarization transformers, the control circuit generating a control signal at the electrical output that controls the polarization state of at least one of the first and the second transformed optical signal.

14. The multi-stage polarization transformer of claim 1 further comprising:
a. a dither signal generator that is electrically connected to an electrical input of the second polarization transformer, the dither signal generator modulating the polarization state of the second transformed optical signal;
b. a polarization selective element that is optically coupled to the output of the second polarization transformer, the polarization selected element passing an optical signal having a predetermined polarization state;
c. an optical detector that is optically coupled to an output of the polarization selective element, the optical detector generating an electrical signal having an amplitude that is related to an amplitude of the optical signal having the predetermined polarization state;
d. a narrow band electrical filter that passes a filtered electrical signal that is related to a frequency of the dither signal; and
e. a control circuit having an electrical input that receives the filtered electrical signal and an electrical output that is electrically coupled to a control input one of the first and the second polarization transformners, the control circuit generating a control signal at the electrical output that controls the polarization state of the second transformed optical signal.

15. The multi-stage polarization transformer of claim 14 wherein the dither signal is a synchronous demodulation dither signal.

16. A method of transforming a polarization state of an input optical signal to a predetermined polarization state, the method comprising:
a. transforming an input optical signal to a first transformed optical signal having a polarization state within a first predetermined range; and
b. transforming the first transformed optical signal to a second transformed optical signal having a polarization state within a second predetermined range, wherein the second predetermined range is less than the first predetermined range.

17. The method of claim 16 wherein the polarization state of the input optical signal is an arbitrary polarization state.

18. The method of claim 16 wherein the first transformed optical signal has a polarization state approximately in a center of the first predetermined range.

19. The method of claim 16 wherein the second transformed optical signal has a polarization state approximately in a center of the second predetermined range.

20. The method of claim 16 further comprising changing the polarization state of the first transformed optical signal in response to the polarization state of the second transformed optical signal.

21. The method of claim 16 further comprising adjusting the polarization state of the first transformed optical signal to a desired polarization state, the adjusting the polarization state comprising:
a. dithering the polarization state of the first transformed optical signal;
b. detecting a portion of the second transformed optical signal having a predetermined state of polarization;
c. converting the portion of the second transformed optical signal having the predetermined state of polarization into an electrical signal;
d. detecting the dither superimposed onto the electrical signal; and
e. adjusting the polarization state of the first transformed optical signal in response to the detecting dither signal.

22. The method of claim 16 further comprising adjusting at least one of the polarization state of the first and the polarization state of the second transformed optical signal to align the polarization state of the second transformed optical signal to an axis of a polarization sensitive element.

23. A multi-stage polarization transformer comprising:
a. a first polarization transformer stage having an input that receives an orthogonally polarized polarization multiplexed optical signal and having an output that generates a first transformed orthogonally polarized polarization multiplexed optical signal, the first transformed orthogonally polarized polarization multiplexed optical signal having polarization states within a first predetermined range; and
b. a second polarization transformer stage having an input that receives the first transformed orthogonally polarized polarization multiplexed optical signal and an output that generates a second transformed orthogonally polarized polarization multiplexed optical signal, the second transformed orthogonally polarized polarization multiplexed optical signal having polarization states within a second predetermined range, wherein the second predetermined range is less than the first predetermined range.

24. The multi-stage polarization transformer of claim 23 wherein the second polarization transformer generates a second transformed orthogonally polarized polarization multiplexed optical signal that has linear polarization states.

25. A method of transforming polarization states of an orthogonally polarized polarization multiplexed optical signal to an orthogonally polarized polarization multiplexed optical signal having predetermined polarization states, the method comprising:
a. transforming an input optical signal having an orthogonally polarized polarization multiplexed optical signal to a first transformed orthogonally polarized polarization multiplexed optical signal having polarization states within a first predetermined range; and
b. transforming the first transformed orthogonally polarized polarization multiplexed optical signal to a second transformed orthogonally polarized polarization multiplexed optical signal having polarization states within a second predetermined range, wherein the second predetermined range is less than the first predetermined range.

26. The method of claim 25 wherein the polarization states of the second transformed orthogonally polarized polarization multiplexed optical signal are substantially linear.
